(19) United States
(12) Patent Application Publication
(10) Pub. No.: US 2014/0307427 A1
(43) Pub. Date: Oct. 16, 2014

(54) LIGHTING DEVICE

(71) Applicant: LG Innotek Co., Ltd., Seoul (KR)

(72) Inventors: Keun Tak JOO, Seoul (KR); Dong Nyung LIM, Seoul (KR); Sang Hoon LEE, Seoul (KR)

(73) Assignee: LG Innotek Co., Ltd., Seoul (KR)

(21) Appl. No.: 14/223,629

(22) Filed: Mar. 24, 2014

(30) Foreign Application Priority Data
Apr. 11, 2013 (KR) 10-2013-0039836
May 2, 2013 (KR) 10-2013-0049520

(51) Int. Cl. F21V 15/06; F21V 23/02; F21V 29/00

(52) U.S. Cl. CPC F21V 15/06; F21V 29/2293; F21V 23/023
USPC 362/186; 362/294

(57) ABSTRACT

A lighting device may be provided that includes: a heat sink having an optical transmittance; a light source module including a substrate disposed on the heat sink and a light emitting device disposed on the substrate; and a cover which is disposed on the light source module and outwardly emits a part of light from the light source module. The cover has an inner surface which reflects a part of light from the light emitting device. The heat sink receives the light from the inner surface of the cover and outwardly emits a part of the received light.

### CROSS-REFERENCE TO RELATED APPLICATION

The present application claims priority under 35 U.S.C. §119(e) of Korean Patent Application No. 10-2013-0039836 filed Apr. 11, 2013 and No. 10-2013-0049520 filed May 2, 2013 the subject matters of which are incorporated herein by reference.

### BACKGROUND

1. Field

Embodiments may relate to a lighting device.

2. Background

A light emitting diode (LED) is an energy device for converting electric energy into light energy. Compared with an electric bulb, the LED has higher conversion efficiency, lower power consumption and a longer life span. As the advantages are widely known, more and more attentions are now paid to a lighting apparatus using the LED.

### SUMMARY

One embodiment is a lighting device. The lighting device includes: a heat sink having an optical transmittance; a light source module including a substrate disposed on the heat sink and a light emitting device disposed on the substrate; and a cover which is disposed on the light source module and outwardly emits a part of light from the light source module. The cover has an inner surface which reflects a part of light from the light emitting device. The heat sink receives the light from the inner surface of the cover and outwardly emits a part of the received light.

Another embodiment is a lighting device. The lighting device includes: a heat sink including a top surface and an outer circumferential portion disposed around the top surface; a light source module including a substrate which is disposed on the top surface and on a portion of the outer circumferential portion, and a light emitting device which is disposed on the substrate; and a cover which is coupled to the outer circumferential portion and disposed on the light source module. The cover reflects a part of light from the light emitting device to the outer circumferential portion, and wherein the outer circumferential portion transmits at least a part of the incident light.

Further another embodiment is a lighting device. The lighting device includes: a light source module which includes a substrate and a light emitting device disposed on the substrate; a hemispherical cover which is disposed on the light source module; and a heat sink on which the light source module is disposed and which is coupled to the cover. The cover includes a first cover part disposed on the substrate, and a second cover part connected to an outer circumference of the first cover part. An optical reflectance of the first cover part is greater than an optical reflectance of the second cover part. The first cover part includes an optical part reflecting at least a part of light from the light emitting device out of a top surface of the substrate.

### BRIEF DESCRIPTION OF THE DRAWINGS

Arrangements and embodiments may be described in detail with reference to the following drawings in which like reference numerals refer to like elements and wherein:

FIG. 1 is a top perspective view of a lighting device according to a first embodiment;

FIG. 2 is a bottom perspective view of the lighting device shown in FIG. 1;

FIG. 3 is an exploded perspective view of the lighting device shown in FIG. 1;

FIG. 4 is an exploded perspective view of the lighting device shown in FIG. 2;

FIG. 5 is a sectional perspective view of the lighting device shown in FIG. 1;

FIGS. 6 and 7 are perspective views showing a state where a light source module 200 and a power supply unit 400 shown in FIG. 3 have been coupled to each other;

FIG. 8 is a conceptual diagram for describing an electrical connection between a substrate 210 and an extension part 450 which are shown in FIGS. 3 and 4;

FIG. 9 is a view for describing a coupling structure between a connection portion 337 and the power supply unit 400;

FIGS. 10 to 11 are views for describing a coupling structure between a support plate 400 and a heat sink 300;

FIG. 12 is a top perspective view of a lighting device according to a second embodiment;

FIG. 13 is a bottom perspective view of the lighting device shown in FIG. 13;

FIG. 14 is an exploded perspective view of the lighting device shown in FIG. 13;

FIG. 15 is an exploded perspective view of the lighting device shown in FIG. 14; and

FIG. 16 is a sectional perspective view of the lighting device shown in FIG. 13.

### DETAILED DESCRIPTION

A thickness or a size of each layer may be magnified, omitted or schematically shown for the purpose of convenience and clearness of description. The size of each component may not necessarily mean its actual size.

It should be understood that when an element is referred to as being ‘on’ or “under” another element, it may be directly on/under the element, and/or one or more intervening elements may also be present. When an element is referred to as being ‘on’ or ‘under’, ‘under the element’ as well as ‘on the element’ may be included based on the element.

An embodiment may be described in detail with reference to the accompanying drawings.

### First Embodiment

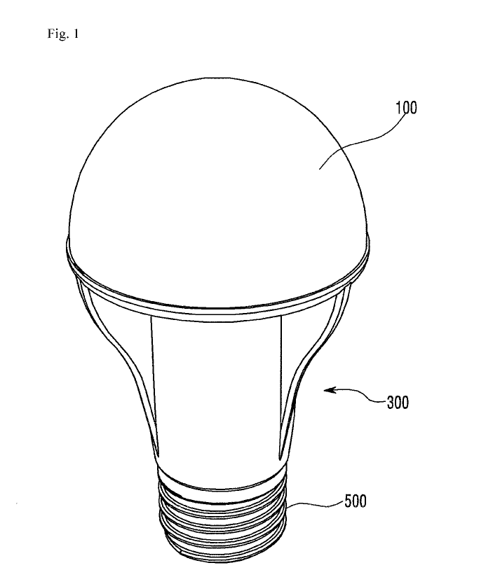

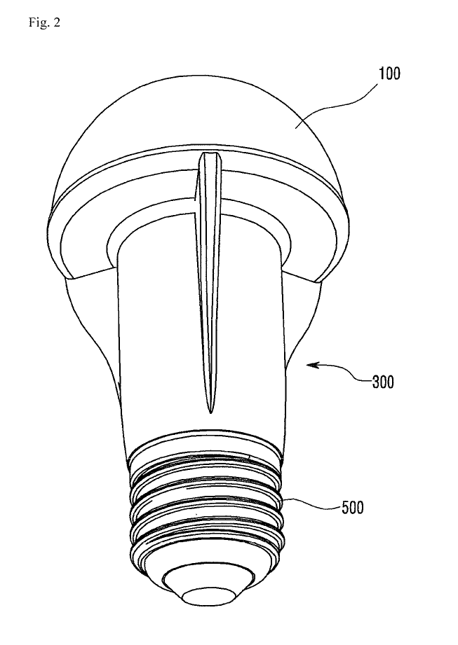

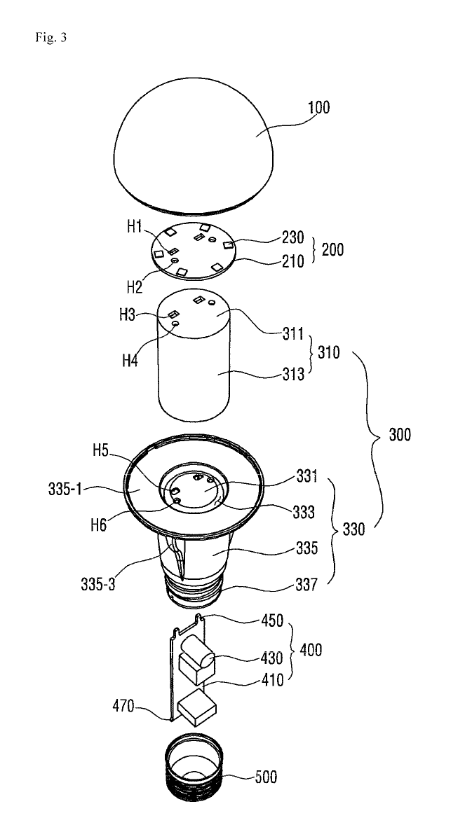

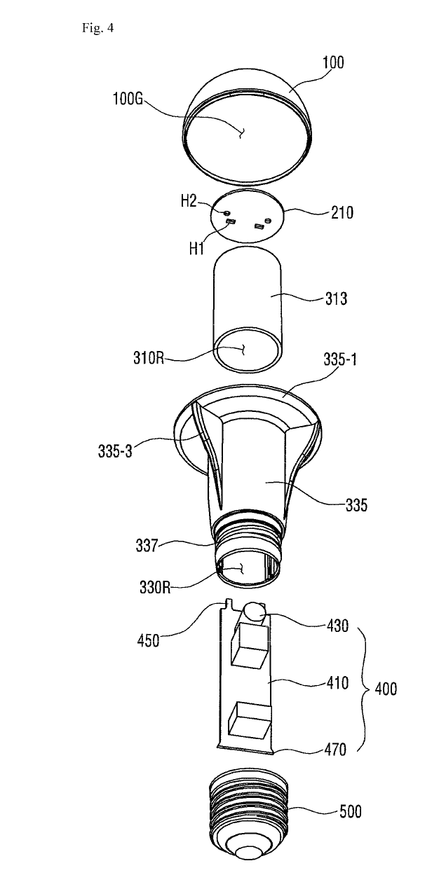

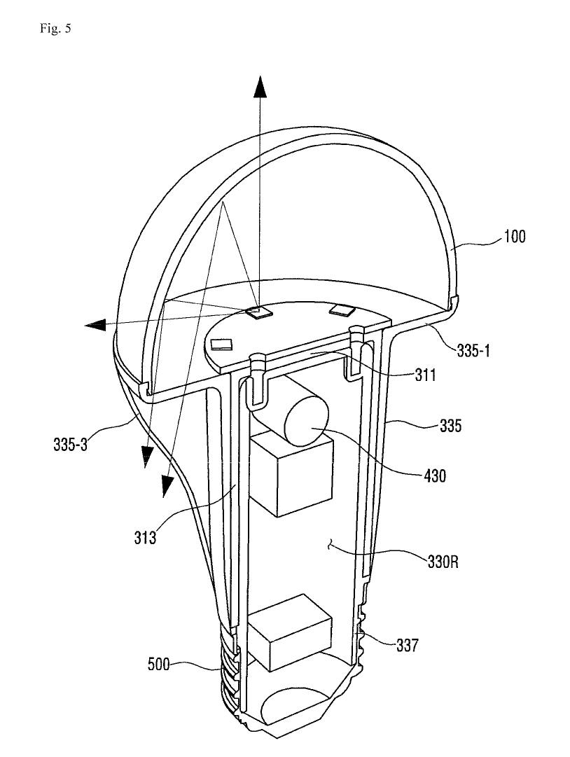

FIG. 1 is a top perspective view of a lighting device according to a first embodiment. FIG. 2 is a bottom perspective view of the lighting device shown in FIG. 1. FIG. 3 is an exploded perspective view of the lighting device shown in FIG. 1. FIG. 4 is an exploded perspective view of the lighting device shown in FIG. 2. FIG. 5 is a sectional perspective view of the lighting device shown in FIG. 1.

Referring to FIGS. 1 to 5, the lighting device according to the first embodiment may include a cover 100, a light source module 200, a heat sink 300, a power supply unit 400, and a base 500. Hereafter, the respective components will be described in detail.

<Cover 100>

The cover 100 has a hemispherical shape or a bulb shape. The cover 100 has an empty interior and a partial opening 100G. Here, it should be understood that the hemispherical shape includes a shape similar to the hemisphere as well as a geometric hemisphere.

An inner diameter of the cover 100 may become greater toward a lower portion from an upper portion of the cover 100.

The cover 100 is optically coupled to the light source module 200. Specifically, the cover 100 may reflect, transmit or diffuse light emitted from the light source module 200.

The cover 100 is coupled to the heat sink 300. Specifically, the cover 100 may be coupled to a second heat radiation part 330 of the heat sink 300. The lower portion of the cover 100 may be coupled to an outer portion 335 of the second heat radiation part 330 of the heat sink 300. Due to the coupling of the cover 100 and the heat sink 300, the light source module 200 is isolated from the outside. Therefore, the light source module 200 can be protected from external impurities or water.

The cover 100 has an outer surface and an inner surface. The inner surface may reflect a part of the light from the light source module 200 and transmit the rest of the light. Particularly, the inner surface of the cover 100 may reflect a part of light from a light emitting device 230 of the light source module 200 toward the outer portion 335 of the second heat radiation part 330 of the heat sink 300.

When the light emitting device 230 of the light source module 200 is an LED, the LED irradiates strong light in a direction of a vertical axis. Therefore, the cover 100 may have a predetermined light diffusion rate. When the cover 100 has a predetermined light diffusion rate (or an optical diffusion material), user's glare can be reduced.

The cover 100 may be formed of any one of glass, plastic, polypropylene (PP), and polyethylene (PE).

The cover 100 may be manufactured by a blow molding process.

<Light Source Module 200>

The light source module 200 is disposed on the heat sink 300 and includes the light emitting device 230 emitting predetermined light toward the cover 100. More specifically, the light source module 200 may include a substrate 210 and the light emitting device 230 disposed on the substrate 210.

The substrate 210 may be formed by printing a circuit pattern on an insulator. For example, the substrate 210 may include a printed circuit board (PCB), a metal core PCB, a flexible PCB, a ceramic PCB and the like.

The substrate 210 may be formed by printing a predetermined circuit pattern on a transparent or opaque resin. Here, the resin may be a thin insulating sheet having the circuit pattern.

The substrate 210 may have a circular plate shape. However, there is no limit to this. The substrate 210 may have a polygonal plate shape or an elliptical plate shape.

The substrate 210 may be disposed on an upper portion 311 of a first heat radiation part 310 and on the outer portion 335 of the second heat radiation part 330. Specifically, a central portion of the substrate 210 may be disposed on a top surface of the upper portion 311 of the first heat radiation part 310, and the rest portion other than the central portion may be disposed on an outer circumferential portion 335-1 of the outer portion 335 of the second heat radiation part 330.

The shape of the substrate 210 may correspond to the shape of the upper portion 311 of the first heat radiation part 310 of the heat sink 300.

A diameter of the substrate 210 may be larger than that of the upper portion 311 of the first heat radiation part 310. When the diameter of the substrate 210 is larger than that of the upper portion 311, a rear light distribution performance of the lighting device according to the first embodiment can be improved. Specifically, if the diameter of the substrate 210 is less than that of the upper portion 311, a part of light reflected by the cover 100 may be blocked by the upper portion 311 incapable of transmitting the light. This may cause the rear light distribution performance of the lighting device to be degraded. Therefore, it is preferred that the diameter of the substrate 210 be larger than that of the upper portion 311.

The surface of the substrate 210 may be coated with a material capable of efficiently reflecting light or may be coated with a color, for example, white, silver and the like. The substrate 210 having the surface made of such a reflective material is able to reflect light incident thereon to the cover 100 again.

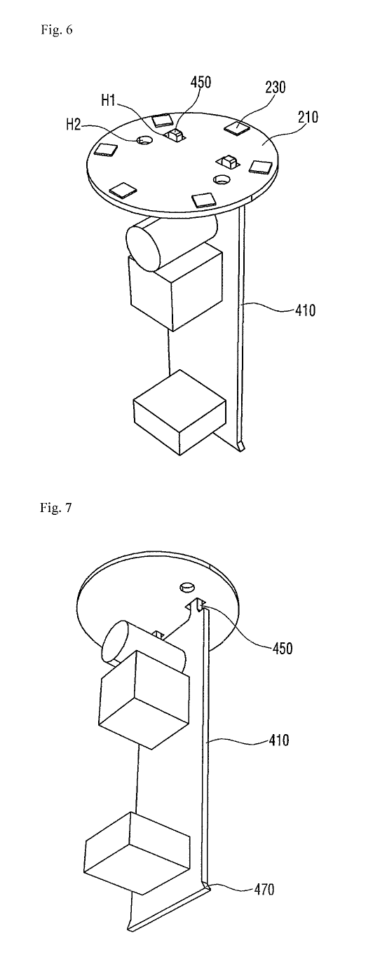

The substrate 210 may have a first hole H1 allowing the substrate 210 to be coupled to the power supply unit 400. Specifically, this will be described with reference to FIGS. 6 to 8.

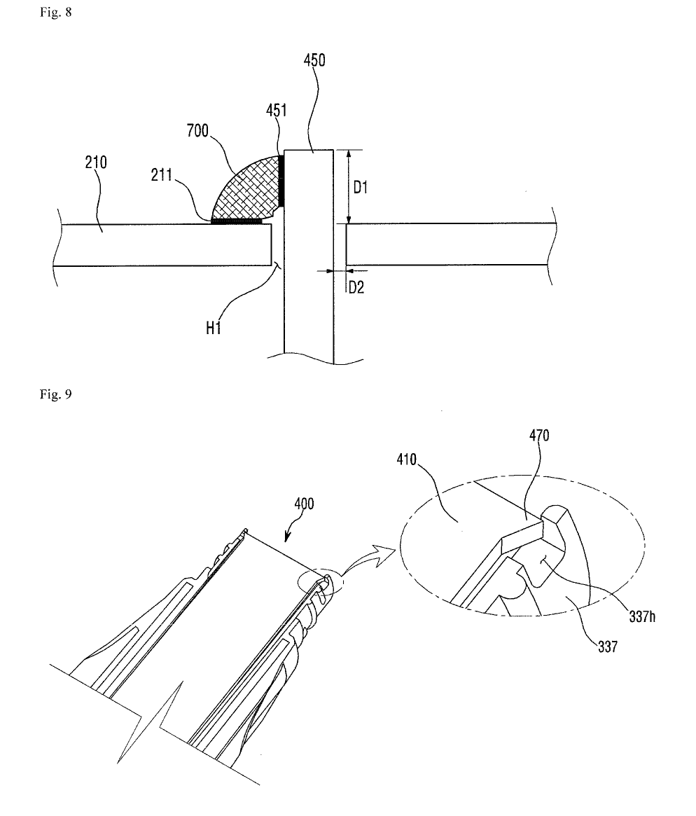

FIGS. 6 and 7 are perspective views showing a state where the light source module 200 and the power supply unit 400 shown in FIG. 3 have been coupled to each other. FIG. 8 is a conceptual diagram for describing an electrical connection between a substrate 210 and an extension part 450 which are shown in FIGS. 3 and 4.

Referring to FIGS. 3 to 8, the substrate 210 has the first hole H1. The extension part 450 of the power supply unit 400 is disposed in the first hole H1.

Here, as shown in FIG. 8, a height D1 from a top surface of the substrate 210 to the end of the extension part 450 which has passed through the first hole H1 of the substrate 210, that is to say, a length D1 of a portion of the extension part 450, which has passed through the first hole H1 of the substrate 210 may be from 1.5 mm to 2.0 mm. If the D1 is less than 1.5 mm, it is difficult to electrically connect the substrate 210 and the extension part 450, so that poor contact may occur between the substrate 210 and the extension part 450. Specifically, the electrical connection between the substrate 210 and the extension part 450 can be performed by soldering. For the sake of the soldering process, a terminal 211 of the substrate 210 and a terminal 451 of the extension part 450 are required to contact with a soldering portion 700. If the D1 is less than 1.5 mm, it is difficult for the terminal 451 of the extension part 450 to sufficiently contact with the soldering portion 700. In this case, the poor contact may occur between the substrate 210 and the extension part 450. Therefore, it is recommended that the D1 should be greater than 1.5 mm. If the D1 is greater than 2.0 mm, a dark portion may be generated at the time of driving the light source module 200. Specifically, the dark portion may be generated in the vicinity of the extension part 450. The dark portion may degrade an optical efficiency of the lighting device and give an unpleasant appearance to users. Therefore, it is recommended that the D1 should be than 2.0 mm.

The shape of the first hole H1 may correspond to the shape of the extended substrate 450. Here, the diameter of the first hole H1 may be larger than the diameter of the extended substrate 450. That is, the size of the first hole H1 may be so large that the extended substrate 450 is inserted into the first hole H1. Therefore, the extended substrate 450 inserted into the first hole H1 may not contact with the substrate 210. In the first hole H1, an interval D2 between the substrate 210 and the extended substrate 450 may be greater than 0 and equal to or less than 0.2 mm. If the D2 is 0, the it may be difficult to insert the extended substrate 450 into the first hole H1 of the substrate 210, and an unintended electrical short-circuit may occur between the extended substrate 450 and the substrate 210. On the other hand, if the D2 is greater than 0.2 mm, soldering materials may pass through the first hole H1 and flow down to a support plate 410 while performing the soldering process. In this case, a printed circuit formed in the support plate 410 may be electrically short-circuited by the soldering materials, and it may be difficult to accurately place the extended substrate 450 at a point where the extended substrate 450 is expected to be disposed in the first hole H1. Therefore, it is recommended that the D2 should be greater than 0 and equal to or less than 0.2 mm.

Referring back to FIGS. 3 to 5, the substrate 210 may have a second hole H2 for fixing the substrate 210 to the heat sink 300. A coupling means like a screw, passes through the second hole H2 of the substrate 210 and is inserted sequentially into a fourth hole H4 and a sixth hole H6 of the heat sink 300, thereby fixing the substrate 210 to the heat sink 300.

A plurality of the light emitting devices 230 may be disposed on one side (or top surface) of the substrate 210. Specifically, the plurality of the light emitting devices 230 may be disposed radially on the one side of the substrate 210.

The light emitting device 230 may be a light emitting diode chip emitting red, green and blue light or a light emitting diode chip emitting ultraviolet light. Here, the light emitting diode chip may have a lateral type or vertical type.

The light emitting device 230 may be a high-voltage (HV) LED package. A HV LED chip within the HV LED package is driven by a DC power supplier and is turned on at a voltage higher than 20V. The HV LED package has a high power consumption of about 1W. For reference, a conventional common LED chip is turned on at a voltage of 2V to 3V. Since the light emitting device 230 which is the HV LED package has the high power consumption of about 1W, the performance equivalent to or similar to that of the conventional common LED chip can be obtained only by a small number of the light emitting devices 230, so that it is possible to reduce the production cost of the lighting device according to the embodiment.

A lens (not shown) may be disposed on the light emitting device 230. The lens (not shown) is disposed to cover the light emitting device 230. The lens (not shown) is able to adjust the orientation angle or direction of the light emitted from the light emitting device 230. The lens (not shown) has a hemispherical shape and may be formed of a light-transmitting resin such as a silicone resin or an epoxy resin without an empty space. The light-transmitting resin may include a wholly or partially distributed phosphor.

When the light emitting device 230 is a blue light emitting diode, the phosphor included in the light-transmitting resin may include at least one of garnet based phosphor (YAG, TAG), silicate based phosphor, nitride based phosphor and oxynitride based phosphor.

It is possible to create natural sunlight (white light) by including only yellow phosphor to the light-transmitting resin. Additionally, green phosphor or red phosphor may be further included in order to improve a color rendering index and to reduce a color temperature.

When many kinds of fluorescent materials are mixed in the light-transmitting resin, an addition ratio of the color of the phosphor may be formed such that the green phosphor is more used than the red phosphor, and the yellow phosphor is more used than the green phosphor. The garnet based phosphor (YAG), the silicate based phosphor and the oxynitride based phosphor may be used as the yellow phosphor. The silicate based phosphor and the oxynitride based phosphor may be used as the green phosphor. The nitride based phosphor may be used as the red phosphor. The light-transmitting resin may be mixed with various kinds of the phosphors or may be configured by a layer including the red phosphor, a layer including the green phosphor and a layer including the yellow phosphor, which are formed separately from each other.

<Heat Sink 300>

The light source module 200 is disposed on the heat sink 300. The heat sink 300 may receive heat radiated from the light source module 200 and radiate the heat.

The power supply unit 400 is disposed in the heat sink 300. The heat sink 300 may receive heat radiated from the power supply unit 400 and radiate the heat.

The heat sink 300 may include the first heat radiation part 310 and the second heat radiation part 330. The first heat radiation part 310 may directly receive the heat from the light source module 200 and radiate the heat. The second heat radiation part 330 may transmit a part of the light reflected from the cover 100 and outwardly emit the light.

The material of the first heat radiation part 310 may be different from that of the second heat radiation part 330. Specifically, the first heat radiation part 310 may be formed of a material incapable of transmitting the light, that is, a material without an optical transmittance, and the second heat radiation part 330 may be formed of a material having a predetermined optical transmittance. When the second heat radiation part 330 is formed of a material having an optical transmittance, a part of the light reflected from the cover 100 can be transmitted outwardly. Accordingly, the rear light distribution performance of the lighting device according to the first embodiment can be improved, and a light distribution angle of the lighting device according to the first embodiment can be increased. Also, the rear light distribution specifications (more than 5% of total flux at 270° to 360° in C₉₀₋₂₇₀) of Energy Star can be satisfied.

The material of the second heat radiation part 330 may be polycarbonate (PC), Poly-dimethyl cyclohexane terephthalate (PCT) and the like. Here, the material of the second heat radiation part 330 is not limited to what is mentioned above. Any material having a predetermined optical transmittance can be used as the material of the second heat radiation part 330.

When the first heat radiation part 310 is formed of a material without an optical transmittance, the power supply unit 400 disposed within the first heat radiation part 310 is not visible from the outside, aesthetic effect can be obtained.

The first heat radiation part 310 may be formed of a non-insulating material, and the second heat radiation part 330 may be formed of an insulating material. The first heat radiation part 310 formed of the non-insulating material is able to quickly radiate the heat emitted from the light source module 200. The outer surface of the heat sink 300 becomes insulating due to the second heat radiation part 330 formed of the insulating material, thereby improving a withstand voltage characteristic of the lighting device and protecting a user from electrical energy. Since the second heat radiation part 330 encloses the power supply unit 400, the power supply unit 400 can be electrically protected.

The first heat radiation part 310 may be formed of a metallic material such as aluminum, copper, magnesium and the like, and the second heat radiation part 330 may be formed of a resin material such as Polycarbonate (PC), Poly-dimethyl cyclohexane terephthalate (PCT), Acrylonitrile (AN), Butadiene (BD) and styrene (SM) (ABS), and the like. Here, the resin-made second heat radiation part 330 may include a heat radiating filler. The heat radiating filler may include at least one of metal powder, ceramic, carbon fiber, graphene, and a carbon nanotube.

It is easier to form the external appearance of the resin-made second heat radiation part 330 than to form the external appearance of a conventional metallic heat sink. Also, poor appearance caused by coating or anodizing the conventional heat sink does not occur in the resin-made second heat radiation part 330. Also, an AC LED can be directly applied. Also, it is possible to reduce the weight and material cost of the entire lighting device.

A first thermal conductivity (W/(mk) or W/m °C.) of the material constituting the first heat radiation part 310 may be greater than a second thermal conductivity of the material constituting the second heat radiation part 330. Since the light source module 200 is disposed closer to the first heat radiation part 310 than to the second heat radiation part 330, when the thermal conductivity of the first heat radiation part 310 is greater than the thermal conductivity of the second heat radiation part 330, it is advantageous for the improvement of heat radiation performance. For example, the first heat radiation part 310 may be formed of aluminum having a high thermal conductivity, and the second heat radiation part 330 may be formed of polycarbonate (PC) or Poly-dimethyl cyclohexane terephthalate (PCT) having a thermal conductivity less than that of the first heat radiation part 310. Here, the first heat radiation part 310 is not limited to the aluminum, and the second heat radiation part 330 is not limited to the PC.

The light source module 200 is disposed on the first heat radiation part 310. Specifically, the substrate 210 and the light emitting devices 230 of the light source module 200 may be disposed on the upper portion 311 of the first heat radiation part 310.

The first heat radiation part 310 may have a receiver 310R receiving the power supply unit 400 and an inner portion 331 of the second heat radiation part 330.

The first heat radiation part 310 may include the upper portion 311 and a lower portion 313. The upper portion 311 and the lower portion 313 may define the receiver 310R.

The upper portion 311 may have a flat plate shape. The substrate 210 and the light emitting devices 230 of the light source module 200 are disposed on the top surface of the upper portion 311, so that the upper portion 311 receives directly the heat from the light source module 200. The upper portion 311 may radiate the heat received from the light source module 200 to the outside or transfer to the lower portion 313.

The top surface of the upper portion 311 may be disposed on the same plane with a top surface 355-1 of the outer portion 335 of the second heat radiation part 330. When the top surface of the upper portion 311 is disposed on the same plane with a top surface of the outer circumferential portion 335-1 of the outer portion 335, the substrate 210 can be stably disposed even though the size of the substrate 210 of the light source module 200 becomes larger than that of the top surface of the upper portion 311.

The shape of the upper portion 311 is not limited to the flat plate shape. For example, the shape of the upper portion 311 may be a plate shape of which a portion, especially, the central portion is upwardly or downwardly convex or may be a hemispherical shape. Also, the upper portion 311 may have various shapes such as a circular shape, an elliptical shape or the like.

The shape of the upper portion 311 may correspond to the shape of the substrate 210. Specifically, the upper portion 311 and the substrate 210 may have a circular shape. The diameter of the upper portion 311 may be less than that of the substrate 210. When the diameter of the upper portion 311 is less than that of the substrate 210, the rear light distribution performance of the lighting device according to the first embodiment can be enhanced. Specifically, unlike the second heat radiation part 330, the first heat radiation part 310 including the upper portion 311 is formed of a material without an optical transmittance. Therefore, if the diameter of the upper portion 311 is greater than that of the substrate 210, a part of the light reflected from the cover 100 is blocked by the upper portion 311, so that the rear light distribution performance of the lighting device according to the first embodiment may be degraded. Accordingly, it is preferred that the diameter of the upper portion 311 should be less than that of the substrate 210.

The upper portion 3112 may have a third hole H3 through which the extension part 450 of the power supply unit 400 passes.

The upper portion 311 may have the fourth hole H4 for fixing the first heat radiation part 310 to the second heat radiation part 330. A coupling means (not shown) like a screw may pass through the fourth hole H4 and be inserted into the sixth hole H6 of the second heat radiation part 330.

The upper portion 311 may be disposed on the inner portion 331 of the second heat radiation part 330. Specifically, the upper portion 311 may be disposed on a top surface of the second heat radiation part 330.

A heat transfer means may be disposed between the upper portion 311 and the substrate 210 of the light source module 200 in order to quickly conduct the heat from the light source module 200 to the upper portion 311. Here, the heat transfer means may be a heat radiating plate (not shown) or a thermal grease.

The lower portion 313 may be disposed within the second heat radiation part 330. Specifically, the lower portion 313 may be disposed in a first receiver 333 of the second heat radiation part 330. When the lower portion 313 is disposed in the first receiver 333 of the second heat radiation part 330, the metallic lower portion 313 does not form the appearance of the lighting device. Accordingly, it is possible to protect users from electrical energy generated from the power supply unit 400. Since a heat sink of an existing lighting device is fully formed of a metallic material and the outer surface of the existing lighting device is formed of a metallic material, electrical energy caused by an inner power supply unit might affect the user. Therefore, by disposing the lower portion 313 in the first receiver 333 of the second heat radiation part 330, it is possible to prevent electrical accidents caused by the power supply unit 400.

The lower portion 313 may be disposed between the inner portion 331 and the outer portion 335 of the second heat radiation part 330. When the lower portion 313 is disposed between the inner portion 331 and the outer portion 335 of the second heat radiation part 330, the metallic lower portion 313 does not form the appearance of the lighting device according to the first embodiment. Accordingly, it is possible to protect users from electrical energy generated from the power supply unit 400.

The lower portion 313 may have a tubular shape with an empty interior or may have a pipe shape. Specifically, the lower portion 313 may have any one of a cylindrical shape, an elliptical tubular shape and a polygonal box shape. The tubular shaped-lower portion 313 may have a constant diameter. Specifically, the diameter of the lower portion 313 may be constant from the top to the bottom of the lower portion 313. With the constant diameter of the lower portion 313 in manufacturing the lighting device according to the first embodiment, it may be possible to easily couple and separate the first heat radiation part 310 to and from the second heat radiation part 330.

The lower portion 313 may have a predetermined length along the longitudinal direction of the second heat radiation part 330. The length of the lower portion 313 may extend from the top to the bottom of the second heat radiation part 330 or may extend from the top to the middle of the second heat radiation part 330. Therefore, the length of the lower portion 313 is not limited to what is shown in the drawings. The heat radiation performance may be enhanced with the increase of the length of the lower portion 313.

A fin structure or an embossed structure (not shown) may be included on at least one of the outer surface and the inner surface of the lower portion 313. When the fin or the embossed structure is included on the lower portion 313, the surface area of the lower portion 313 itself is increased, so that the heat radiating area is increased. As a result, the heat radiation performance of the heat sink 300 can be improved.

The upper portion 311 and the lower portion 313 may be integrally formed with each other. In the present specification, it may mean that the individual upper portion 311 and the individual lower portion 313 are not connected by welding or bonding them, but the upper portion 311 and the lower portion 313 are connected as one to each other without being physically separated. When the upper portion 311 and the lower portion 313 are integrally formed with each other, the contact resistance between the upper portion 311 and the lower portion 313 is close to 0. Therefore, a heat transfer rate from the upper portion 311 to the lower portion 313 is higher than that when the upper portion 311 and the lower portion 313 are not integrally formed with each other. Also, when the upper portion 311 and the lower portion 313 are integrally formed with each other, a process of coupling them, for example, a press processing and the like, is not required, so that the cost in the manufacturing process can be reduced.

The second heat radiation part 330, together with the cover 100, may form the appearance of the lighting device according to the embodiment and may receive the first heat radiation part 310 and the power supply unit 400.

The first heat radiation part 310 is disposed within the second heat radiation part 330. Specifically, the second heat radiation part 330 may include the first receiver 330 receiving the lower portion 313. Here, the first receiver 333 may receive the upper portion 311 of the first heat radiation part 310 as well. The first receiver 333 is formed between the inner portion 331 and the outer portion 335 of the second heat radiation part 330, and may have a predetermined depth corresponding to the length of the lower portion 313.

The second heat radiation part 330 may include a second receiver 330R receiving the power supply unit 400. Here, unlike a receiver of the heat sink of a conventional lighting device, the second receiver 330R is formed of a non-insulating resin material. Therefore, the power supply unit 400 received in the second receiver 330R can be used as a non-insulating PSU. The manufacturing cost of the non-insulating PSU is lower than that of an insulating PSU, so that the manufacturing cost of the lighting device can be reduced.

The second heat radiation part 330 may include the inner portion 331, the outer portion 335, and a connection portion 337.

The inner portion 331 of the second heat radiation part 330 is disposed in the receiver 310R of the first heat radiation part 310. In order that the inner portion 331 of the second heat radiation part 330 is disposed in the receiver 310R of the first heat radiation part 310, the inner portion 331 of the second heat radiation part 330 may have a shape corresponding to the shape of the receiver 310R of the first heat radiation part 310.

The substrate 210 of the light source module 200 is disposed on the top surface of the inner portion 331.

The inner portion 331 may have the second receiver 330R receiving the power supply unit 400.

The inner portion 331 may have a fifth hole H5 through which the extension part 450 of the power supply unit 400 disposed in the second receiver 330R passes. Also, the inner portion 331 may have the sixth hole H6 for fixing the substrate 210 and the first heat radiation part 310 to the second heat radiation part 330.

The outer portion 335 of the second heat radiation part 330 encloses the first heat radiation part 310. Here, the outer portion 335 of the second heat radiation part 330 may have a shape corresponding to the appearance of the first heat radiation part 310. Therefore, the inner portion 331 of the second heat radiation part 330, the first heat radiation part 310, and the outer portion 335 of the second heat radiation part 330 may have shapes corresponding to each other.

The outer portion 335 may include the outer circumferential portion 335-1. The outer circumferential portion 335-1 may extend outwardly from the top of the outer portion 335. The top surface of the outer circumferential portion 335-1 may be disposed on the same plane with the top surface of the inner portion 331. The edge of the outer circumferential portion 335-1 is coupled to the end of the cover 100. The substrate 210 may be disposed on the top surface of the outer circumferential portion 335-1.

As shown in FIG. 5, the outer circumferential portion 335-1 may transmit at least a part of the light from the cover 100 and reflect the rest of the light to the cover 100 again. Since the outer circumferential portion 335-1 transmits the light, the lighting device is able to emit the light backward. Therefore, the rear light distribution performance of the lighting device according to the first embodiment can be improved.

The outer portion 335 may have a fin 335-3. The fin 335-3 increases the surface area of the outer portion 335 of the second heat radiation part 330, so that the heat radiation performance of the heat sink 300 can be improved. However, since the fin 335-3 increases the thickness of the outer portion 335, the light is not able to transmit through the fin 335-3, so that a dark portion may be generated in the fin 335-3. Therefore, it is recommended that the number of the fins 335-3 should be as small as possible, specifically, should be from 2 to 4.

The connection portion 337 of the second heat radiation part 330 may be formed of an insulating material and connected to the lower portions of the inner portion 331 and the outer portion 335. The connection portion 337 is coupled the base 500. The connection portion 337 may have a screw thread corresponding to a screw groove formed in the base 500. The connection portion 337, together with the inner portion 331, may form the second receiver 330R.

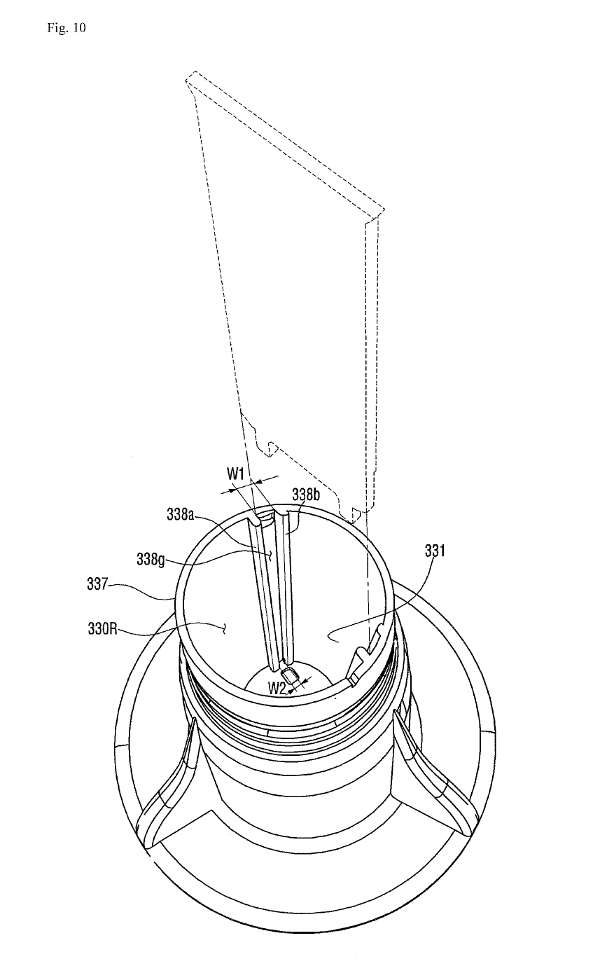

The connection portion 337 is coupled to the power supply unit 400, and thereby fixing the power supply unit 400 within the second receiver 330R. Hereafter, this will be described with reference to FIG. 9.

FIG. 9 is a view for describing a coupling structure between the connection portion 337 and the power supply unit 400.

Referring to FIG. 9, the connection portion 337 has a coupling recess 337h. The coupling recess 337h has a predetermined diameter allowing a protrusion 470 of the support plate 410 to be inserted into the coupling recess 337h. The protrusion 470 may be formed in accordance with the number of the protrusions 470 of the support plate 410.

The support plate 410 of the power supply unit 400 has the protrusion 470 which is coupled to the coupling recess 337h of the connection portion 337. The protrusion 470 may extend outwardly from both corners of the lower portion of the support plate 410. The protrusion 470 has a shape in such manner that it is easy for the support plate 410 to be received in the second receiver 330R and it is hard for the support plate 410 to come out of the second receiver 330R. For example, the protrusion 470 may have a hook shape.

When the protrusion 470 of the support plate 410 is coupled to the coupling recess 337h of the connection portion 337, it is hard for the support plate 410 to come out of the second receiver 330R, thereby firmly fixing the support plate 410 within the second receiver 330R. Therefore, a separate additional process, for example, a molding process of the power supply unit 400 is not required, so that the manufacturing cost of the lighting device can be reduced.

Referring back to FIGS. 1 to 5, the first receiver 333 of the second heat radiation part 330 is formed between the inner portion 331 and the outer portion 335 of the second heat radiation part 330, and receives the lower portion 313 of the first heat radiation part 310. The first receiver 333 may have a predetermined depth as much as the length of the lower portion 313 of the first heat radiation part 310. Here, the first receiver 333 does not completely separate the inner portion 331 and the outer portion 335. That is, it is intended that the first receiver 333 is not formed between the lower portion of the inner portion 331 and the lower portion of the outer portion 335, so that the inner portion 331 and the outer portion 335 may be connected to each other.

After the first heat radiation part 310 and the second heat radiation part 330 are separately produced, the first heat radiation part 310 may be coupled to the second heat radiation part 330. Specifically, after the first heat radiation part 310 is inserted into the first receiver 333 of the second heat radiation part 330, the first heat radiation part 310 and the second heat radiation part 330 may be coupled to each other through a bonding process or a coupling process.

Meanwhile, the first heat radiation part 310 and the second heat radiation part 330 are integrally formed with each other. Also, the mutually coupled first and second heat radiation parts 310 and 330 may be limited to separate from each other. Specifically, the first heat radiation part 310 and the second heat radiation part 330 are in a state of being stuck together by a predetermined process. Therefore, the first heat radiation part 310 and the second heat radiation part 330 are difficult to separate. Here, it is noted that the first heat radiation part 310 and the second heat radiation part 330 have been separated in FIGS. 3 to 4 for the sake of convenience of the description. In the present specification, it should be understood that the fact that first heat radiation part 310 and the second heat radiation part 330 are integrally formed with each other or limited to separate from each other does not mean that they are not separated by any force, but means that it is possible to separate them by a predetermined force relatively greater than the force of human, for example, a mechanical force, and means that it is difficult to return to the previous state of having been coupled if the first heat radiation part 310 and the second heat radiation part 330 are separated from each other by the predetermined force.

When the first heat radiation part 310 and the second heat radiation part 330 are integrally formed with each other or limited to separate from each other, a contact resistance between the metallic first heat radiation part 310 and the resin made-second heat radiation part 330 may be less than a contact resistance in a case where the first heat radiation part 310 and the second heat radiation part 330 are not integrally formed with each other. Thanks to the reduced contact resistance, it is possible to obtain a heat radiation performance same as or similar to that of the conventional heat sink (entirely formed of a metallic material). Further, when the first and second heat radiation parts 310 and 330 are integrally formed, the breakage and damage of the second heat radiation part 330 caused by external impact can be more reduced than when the first heat radiation part 310 and the second heat radiation part 330 are not integrally formed with each other.

An insert injection process may be used to integrally form the first heat radiation part 310 and the second heat radiation part 330. The insert injection process is formed as follows. After, the previously manufactured first heat radiation part 310 is put into a mold (frame) for molding the second heat radiation part 330, a material constituting the second heat radiation part 330 is molten and put into the mold, and then is injected.

<Power Supply Unit 400>

The power supply unit 400 may include the support plate 410 and a plurality of parts 430.

The support plate 410 mounts the plurality of parts 430. The support plate 410 may receive a power signal supplied through the base 500 and may have a printed pattern through which a predetermined power signal is supplied to the light source module 200.

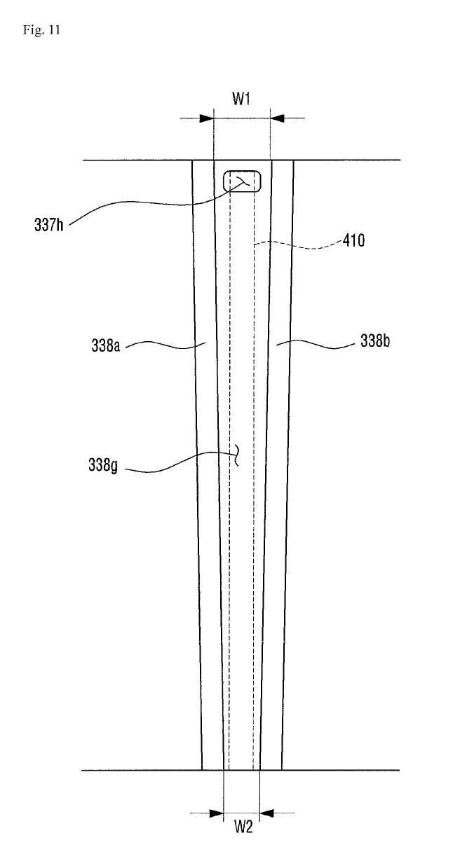

The support plate 410 may have a quadrangular plate shape. The support plate 410 is received in the second receiver 330R of the second heat radiation part 330. Specifically, this will be described with reference to FIGS. 10 to 11.

FIGS. 10 to 11 are views for describing a coupling structure between the support plate 410 and the heat sink 300.

Referring to FIGS. 10 to 11, the second heat radiation part 330 may include a first and a second guides 338a and 338b which guide both sides of one edge of the support plate 410 respectively. The first and second guides 338a and 338b are disposed within the second receiver 330R of the second heat radiation part 330. The first and second guides 338a and 338b have a predetermined length toward the bottom surface of the second receiver 330R from the entrance of the second receiver 330R. The first and second guides 338a and 338b may protrude upwardly from the inner surface of the second heat radiation part 330 which forms the second receiver 330R. A guide recess 338g into which one side of the support plate 410 is inserted may be formed between the first guide 338a and the second guide 338b.

An interval between the first guide 338a and the second guide 338b may be reduced toward the inside of the second receiver 330R (W1>W2). In other words, a diameter of the guide recess 338g may be reduced toward the inside of the second receiver 330R (W1>W2). As such, when the interval between the first guide 338a and the second guide 338b or the diameter of the guide recess 338g is reduced toward the inside of the second receiver 330R (W1>W2), a process of inserting the support plate 410 into the second receiver 330R becomes easier, and the support plate 410 can be precisely coupled to the inside of the heat sink 300.

In the entrance of the second receiver 330R, for the purpose of improving the work efficiency of a worker by allowing the support plate 410 to be easily inserted into the second receiver 330R, it is recommended that the interval W1 between the first guide 338a and the second guide 338b should be greater than a value obtained by adding 1 mm to the thickness of the support plate 410. In other words, it is recommended that an interval between the first guide 338a and one surface of the support plate 410 should be greater than 0.5 mm.

In the bottom surface of the second receiver 330R, for the purpose of accurately disposing the support plate 410 at a designed position, it is recommended that the interval W2 between the first guide 338a and the second guide 338b should be greater than the thickness of the support plate 410 and less than a value obtained by adding 0.1 mm to the thickness of the support plate 410. In other words, it is recommended that the interval between the first guide 338a and one surface of the support plate 410 should be greater than 0.05 mm.

The coupling recess 337h into which the protrusion 470 of the support plate 410 is inserted is formed between the first guide 338a and the second guide 338b. Since the coupling recess 337h is formed between the first guide 338a and the second guide 338b, the support plate 410 can be disposed at a more accurate position and prevented from being separated.

The support plate 410 may include the extended substrate 450. The extended substrate 450 extends outwardly from the top of the support plate 410. The extended substrate 450 passes through the fifth hole H5 of the heat sink 300 and the first hole H1 of the substrate 210, and then is electrically connected to the substrate 210 through the soldering process. Here, the extension part 450 may be designated as an extended substrate.

The support plate 410 may include the protrusion 470. The protrusion 470 extends outwardly from both corners of the lower portion of the support plate 410. The protrusion 470 is coupled to the connection portion 337 of the heat sink 300.

The plurality of the parts 430 are mounted on the support plate 410. The plurality of the parts 430 may include, for example, a DC converter converting AC power supply supplied by an external power supply into DC power supply, a driving chip controlling the driving of the light source module 200, and an electrostatic discharge (ESD) protective device for protecting the light source module 200. However, there is no limit to this.

Since walls defining the second receiver 330R of the second heat radiation part 330 are formed of an insulating material, for example, a resin material, the power supply unit 400 may be the non-insulating PSU. If the power supply unit 400 is the non-insulating PSU, the manufacturing cost of the lighting device can be reduced.

<Base 500>

The base 500 is coupled to the connection portion 337 of the heat sink 300 and is electrically connected to the power supply unit 400. The base 500 transmits external AC power to the power supply unit 400.

The base 500 may have the same size and shape as those of the base of a conventional incandescent bulb. For this reason, the lighting device according to the embodiment can take the place of the conventional incandescent bulb.

Unlike a conventional lighting device including a heat sink incapable of transmitting the light, it can be found that the heat sink of the lighting device according to the embodiment also emits predetermined light. Therefore, without necessities of vertically disposing the light source module and of disposing a separate lens on the light source module for the purpose of the rear light distribution, the lighting device according to the embodiment is able to obtain the rear light distribution. Further, the light distribution angle of the lighting device according to the embodiment is greater than that of the conventional heat sink.

### Second Embodiment

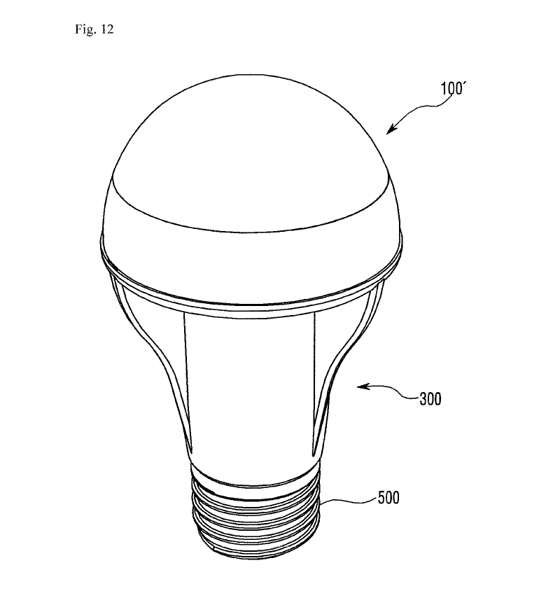

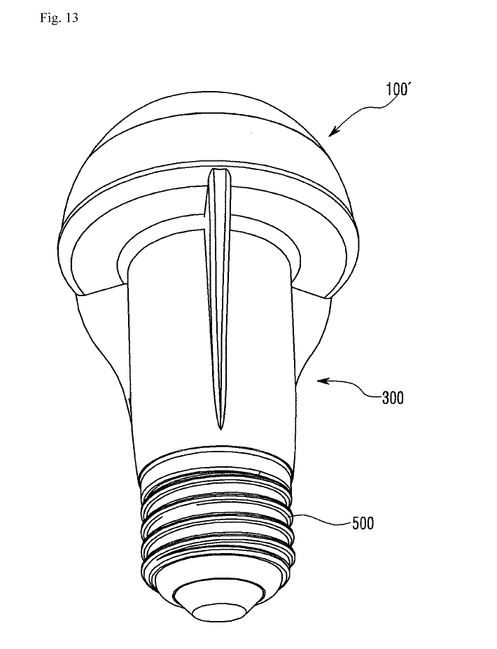

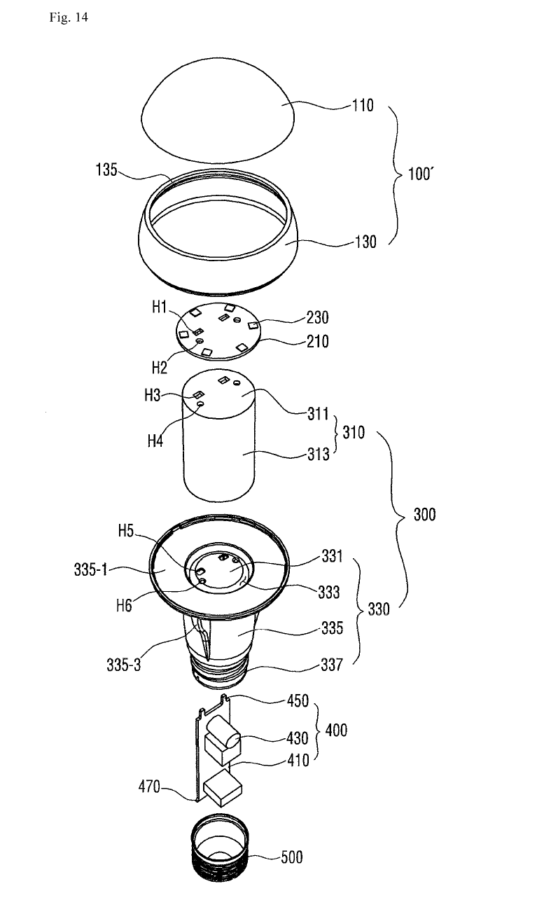

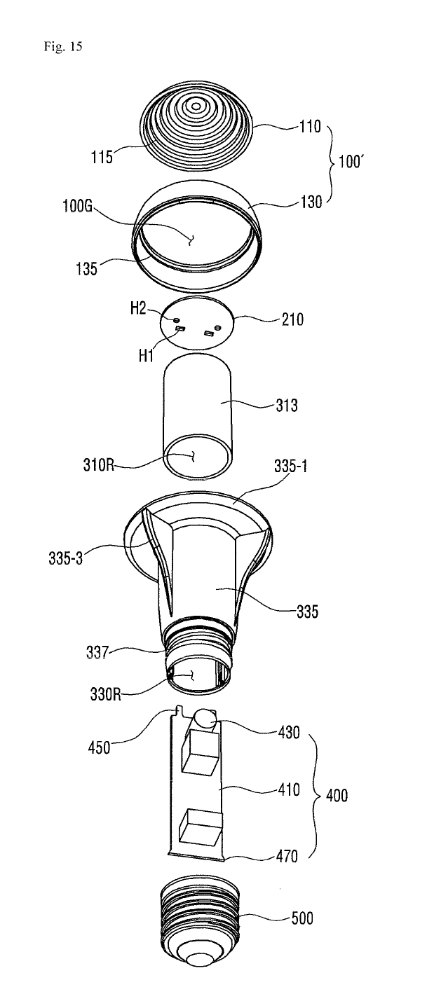

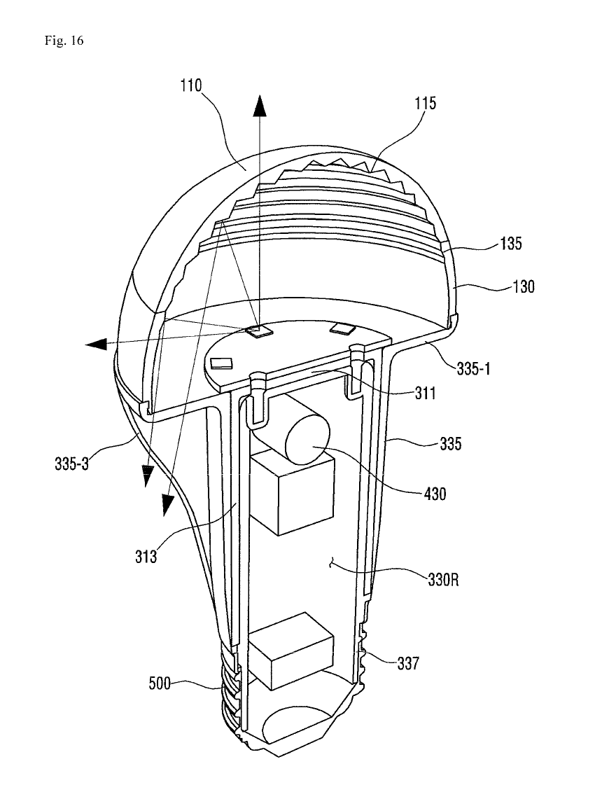

FIG. 12 is a top perspective view of a lighting device according to a second embodiment. FIG. 13 is a bottom perspective view of the lighting device shown in FIG. 12 FIG. 14 is an exploded perspective view of the lighting device shown in FIG. 12. FIG. 15 is an exploded perspective view of the lighting device shown in FIG. 13. FIG. 16 is a sectional perspective view of the lighting device shown in FIG. 12.

Referring to FIGS. 12 to 16, the lighting device according to the second embodiment may include a cover 100′, the light source module 200, the heat sink 300, the power supply unit 400, and the base 500.

Since the light source module 200, the heat sink 300, the power supply unit 400, and the base 500 are the same as the light source module 200, the heat sink 300, the power supply unit 400, and the base 500 of the lighting device according to the first embodiment shown in FIGS. 1 to 11, detailed descriptions of the light source module 200, the heat sink 300, the power supply unit 400, and the base 500 will be replaced by the foregoing descriptions. Hereafter, the cover 100′ will be described in detail.

The material of the cover 100′ may be the same as that of the cover 100 shown in FIGS. 1 to 11.

The cover 100′ may include a first cover part 110 and a second cover part 130. Here, the first cover part 110 may be designated as an upper portion, and the second cover part 130 may be designated a lower portion. Here, the cover 100′ is not limited to only the two of the first cover part 110 and the second cover part 130. For example, the cover 100′ may be comprised of three cover parts. Therefore, the cover 100′ may be comprised of at least two cover parts.

The first cover part 110 and the second cover part 130 are coupled to each other, thereby forming the cover 100′ having a hemispherical shape or a bulb shape. The first cover part 110 and the second cover part 130 can be coupled to each other by an adhesive material or by a predetermined coupling structure, for example, a screw thread/screw groove structure, a hook structure, and the like.

The first cover part 110 may be disposed on the substrate 210 of the light source module 200, and the second cover part 130 may be disposed around the substrate 210 of the light source module 200.

The second cover part 130 may be disposed under the first cover part 110 and may be connected to an outer circumference of the first cover part 110.

The diameter of the cover 100′ becomes larger toward the lower portion of the second cover part 130 from the upper portion of the first cover part 110.

The first cover part 110 may have an outer surface and an inner surface. An optical part 115 may be disposed on the inner surface of the first cover part 110.

As shown in FIG. 5, the optical part 115 may transmit a part of the light from the light emitting device 230 of the light source module 200 and reflect the rest of the light toward the outer circumferential portion 335-1 of the heat sink 300 or out of the top surface of the substrate 210. The optical part 115 is the inner surface itself of the first cover part 110 and may have a prism shape.

The optical part 115 may be a prism sheet attached to the inner surface of the first cover part 110. Due to the optical part 115, the rear light distribution performance of the lighting device according to the second embodiment can be more improved than that of the lighting device according to the first embodiment.

Here, as shown in FIG. 5, the optical part 115 may be disposed on the entire inner surface of the first cover part 110. However, the optical part 115 is not limited to this. The optical part 115 may be disposed on a portion of the inner surface of the first cover part 110. The optical part 115 is disposed on the entire or a portion of the inner surface of the first cover part 110 in accordance with the shape of the light source module 200 or the light distribution of the lighting device.

The second cover part 130 is disposed under the first cover part 110 and has an inner surface and an outer surface. An optical part 135 may be disposed on the inner surface of the second cover part 130.

As shown in FIG. 5, the optical part 135 may transmit a part of the light from the light source module 200 and reflect the rest of the light toward the outer circumferential portion 335-1 of the heat sink 300 or out of the top surface of the substrate 210. The optical part 135 is the inner surface itself of the second cover part 130 and may have a prism shape. The optical part 135 may be a prism sheet attached to the inner surface of the second cover part 130. Due to the optical part 135, the rear light distribution performance of the lighting device according to the second embodiment can be more improved than that of the lighting device according to the first embodiment.

Here, as shown in FIG. 5, the optical part 135 may be disposed on a portion of the inner surface of the second cover part 130. However, the optical part 135 is not limited to this. The optical part 135 may be disposed on the entire inner surface of the second cover part 130. The optical part 135 is disposed on a portion of or the entire inner surface of the second cover part 130 in accordance with the shape of the light source module 200 or the light distribution of the lighting device.

The second cover part 130 may be coupled to the heat sink 300. Specifically, the lower portion of the second cover part 130 may be coupled to the outer circumferential portion 335-1 of the second heat radiation part 330 of the heat sink 300. Due to the coupling of the second cover part 130 and the heat sink 300, the light source module 200 is isolated from the outside. Therefore, the light source module 200 can be protected from external impurities or water.

The material of the cover 100′ may have an optical diffusion material for the purpose of preventing a user from feeling glare caused by the light emitted from the light source module 200.

A light diffusion rate of the first cover part 110 may be higher than that of the second cover part 130. When the light diffusion rate of the first cover part 110 is higher than that of the second cover part 130, the rear light distribution performance of the lighting device according to the second embodiment can be more improved. Specifically, when the light diffusion rate of the first cover part 110 is higher than that of the second cover part 130, the first cover part 110 is able to reflect more light from the light source module 200 than the second cover part 130. More specifically, referring to FIG. 5, since the first cover part 110 is disposed on the light source module 200 and the second cover part 130 is disposed around the light source module 200, the first cover part 110 receives more light from the light source module 200 than the second cover part 130. Therefore, when the light diffusion rate of the first cover part 110 is higher than that of the second cover part 130, the amount of the light which is reflected to the heat sink 300 becomes increased, so that the rear light distribution performance of the lighting device according to the second embodiment can be more enhanced.

Also, when the light diffusion rate of the first cover part 110 is higher than that of the second cover part 130, user's glare can be alleviated. Specifically, when the light emitting device 230 of the light source module 200 is an LED, the LED irradiates strong light in a vertical axis. Therefore, the first cover part 110 disposed on the light source module 200 emits light stronger than that from the second cover part 130 disposed around the light source module 200. Accordingly, the light diffusion rate of the first cover part 110 becomes higher than that of the second cover part 130, so that it is possible to alleviate the user's glare.

An optical reflectance of the first cover part 110 may be greater than that of the second cover part 130. When the optical reflectance of the first cover part 110 is greater than that of the second cover part 130, the rear light distribution performance of the lighting device according to the second embodiment can be more enhanced and the user's glare can be alleviated.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A lighting device comprising:
a heat sink having an optical transmittance;
a light source module including a substrate disposed on the heat sink and a light emitting device disposed on the substrate; and
a cover which is disposed on the light source module and outwardly emits a part of light from the light source module,
wherein the cover has an inner surface which reflects a part of light from the light emitting device, and wherein the heat sink receives the light from the inner surface of the cover and outwardly emits a part of the received light.

2. The lighting device of claim 1, wherein the heat sink comprises:
a first heat radiation part including an upper portion on which the light source module is disposed, a lower portion connected to the upper portion, and a receiver; and
a second heat radiation part including an inner portion which is disposed in the receiver of the first heat radiation part, and an outer portion which encloses the lower portion of the first heat radiation part,
wherein the second heat radiation part has the optical transmittance, and wherein the outer portion of the second heat radiation part emits outwardly a part of light incident from the inner surface of the cover.

3. The lighting device of claim 2, wherein the first heat radiation part and the second heat radiation part are integrally formed with each other.

4. The lighting device of claim 2, further comprising a power supply unit supplying power to the light source module, wherein the second heat radiation part is formed of an insulating material, and wherein the inner portion of the second heat radiation part comprises a receiver receiving the power supply unit.

5. The lighting device of claim 4,
wherein the power supply unit comprises a support plate and a plurality of parts disposed on the support plate,
wherein the second heat radiation part further comprises a connection portion which is formed of an insulating material and allows the second heat radiation part to be connected to a base,
wherein the connection portion has at least one hole, and
wherein the support plate has a protrusion which has a hook structure and is inserted into the hole of the connection portion.

6. The lighting device of claim 4,
wherein the power supply unit comprises a support plate and a plurality of parts disposed on the support plate,
wherein the second heat radiation part comprises a first guide and a second guide which are disposed in the receiver of the second heat radiation part and guide both sides of one edge of the support plate, and
wherein an interval between the first guide and the second guide is reduced toward a bottom surface of the receiver of the second heat radiation part from an entrance of the receiver of the second heat radiation part.

7. A lighting device comprising:
a heat sink including a top surface and an outer circumferential portion disposed around the top surface;
a light source module including a substrate which is disposed on the top surface and on a portion of the outer circumferential portion, and a light emitting device which is disposed on the substrate; and
a cover which is coupled to the outer circumferential portion and disposed on the light source module,
wherein the cover reflects a part of light from the light emitting device to the outer circumferential portion, and wherein the outer circumferential portion transmits at least a part of the incident light.

8. The lighting device of claim 7, wherein the top surface of the heat sink is disposed on the same plane with a top surface of the outer circumferential portion of the heat sink.

9. The lighting device of claim 7, wherein the top surface of the heat sink is formed of a metallic material, and wherein the outer circumferential portion of the heat sink is formed of a resin material.

10. The lighting device of claim 7, wherein the heat sink comprises:
a first heat radiation part which comprises an upper portion including the top surface, a lower portion connected to the upper portion, and a receiver; and
a second heat radiation part comprising an inner portion disposed in the receiver of the first heat radiation part, and an outer portion which encloses the first heat radiation part and has the outer circumferential portion,
wherein the first heat radiation part has a first thermal conductivity, wherein the second heat radiation part has a second thermal conductivity, and wherein the first thermal conductivity is greater than the second thermal conductivity.

11. A lighting device comprising:
a light source module which includes a substrate and a light emitting device disposed on the substrate;
a hemispherical cover which is disposed on the light source module; and
a heat sink on which the light source module is disposed and which is coupled to the cover,
wherein the cover includes a first cover part disposed on the substrate, and a second cover part connected to an outer circumference of the first cover part,
wherein an optical reflectance of the first cover part is greater than an optical reflectance of the second cover part, and
wherein the first cover part includes an optical part reflecting at least a part of light from the light emitting device out of a top surface of the substrate.

12. The lighting device of claim 11, wherein the second cover part further comprises an optical part reflecting at least a part of light from the light emitting device out of the top surface of the substrate.

13. The lighting device of claim 11, wherein a light diffusion rate of the first cover part is higher than a light diffusion rate of the second cover part.

14. The lighting device of claim 11, wherein the optical part has a prism shape.

15. The lighting device of claim 11, wherein the heat sink comprises:
a first heat radiation part on which the light source module is disposed; and
a second heat radiation part which receives the first heat radiation part and is coupled to the second cover part,
wherein the second heat radiation part has a predetermined optical transmittance.

16. The lighting device of claim 15,
wherein the first heat radiation part comprises an upper portion including a top surface, a lower portion connected to the upper portion, and a receiver,
wherein the second heat radiation part comprises an inner portion disposed in the receiver of the first heat radiation part, and an outer portion which encloses the first heat radiation part and has an outer circumferential portion, and
wherein a thermal conductivity of the first heat radiation part is greater than a thermal conductivity of the second heat radiation part.

17. The lighting device of claim 16, further comprising a power supply unit supplying power to the light source module, wherein the first heat radiation part is formed of a non-insulating material, and the second heat radiation part is formed of an insulating material, and wherein the second heat radiation part comprises a receiver receiving the power supply unit.

18. The lighting device of claim 17,
wherein the power supply unit comprises a support plate and a plurality of parts disposed on the support plate, and
wherein the support plate comprises an extension part which passes sequentially through the inner portion of the second heat radiation part, the upper portion of the first heat radiation part, and the substrate, and is electrically connected to the substrate.

19. The lighting device of claim 17,
wherein the power supply unit comprises a support plate and a plurality of parts disposed on the support plate,
wherein the second heat radiation part further comprises a connection portion which allows the second heat radiation part to be connected to a base,
wherein the connection portion has at least one hole, and
wherein the support plate has a protrusion which has a hook structure and is inserted into the hole of the connection portion.

20. The lighting device of claim 17,
wherein the power supply unit comprises a support plate and a plurality of parts disposed on the support plate,
wherein the second heat radiation part comprises a first guide and a second guide which are disposed in the receiver of the second heat radiation part and guide both sides of one edge of the support plate, and
wherein an interval between the first guide and the second guide is reduced toward a bottom surface of the receiver of the second heat radiation part from an entrance of the receiver of the second heat radiation part.
